(19) United States
(12) Patent Application Publication
(10) Pub. No.: US 2026/0322677 A1
(43) Pub. Date: Oct. 15, 2026

(54) METHOD FOR FAULT COMMUNICATION AND HANDLING IN IN-VEHICULAR NETWORKS USING AUTOMOTIVE ETHERNET, PARTICULARLY FOR SAFETY-CRITICAL IN-VEHICULAR NETWORKS

(71) Applicant: SILICONALLY GMBH, Dresden (DE)

(72) Inventors: Benedikt SCHONLAU, Dresden (DE); Nitin Krishna VENKATESAN, Dresden (DE); Emrah ONAT, Dresden (DE)

(73) Assignee: SILICONALLY GMBH, Dresden (DE)

(21) Appl. No.: 19/467,023

(22) Filed: Feb. 2, 2026

(30) Foreign Application Priority Data
Feb. 10, 2025 (IT) 102025000002478

(51) Int. Cl. H04L 41/06; H04L 12/46; H04L 43/0811; H04L 45/28

(52) U.S. Cl. CPC H04L 41/06; H04L 12/46; H04L 43/0811; H04L 45/28

(57) ABSTRACT

A method for fault communication and handling in In-vehicular networks (1) using automotive ethernet, particularly for safety-critical In-vehicular networks includes:
detecting a critical event at one of the network nodes (2, 3), wherein the critical event is detected by the network node (2, 3) affected by the critical event or by a network node (2, 3) connected to the network node (2, 3) affected by the critical event;
generating a critical-event message at the physical layer and/or data link layer (4) of the network node (2, 3) detecting the critical event;
broadcasting the critical-event message to the multiple network nodes (2, 3) ; and
receiving and processing the critical event message at the physical layer and/or data link layer (4).

The invention generally relates to Fault communication/handling in Automotive Systems using Automotive Ethernet. The invention particularly relates to a method for fault communication and handling in In-vehicular networks using automotive ethernet, particularly for safety-critical In-vehicular networks, wherein the In-vehicular network comprises multiple network nodes like network switches and end devices, which are interconnected in a network structure. The invention further relates to an automotive ethernet device for fault communication and handling in In-vehicular networks, wherein the system is configured to implement the method according to the invention.

The growing demand for safer, smarter, and more comfortable vehicles continues to drive innovation in the automotive industry. Today, a typical car equips around 80 to 150 Electronic Control Units (ECUs) along with numerous sensors and actuators that manage various in-vehicle functions. Features like Advanced Driver Assistance Systems (ADAS), including Driver Monitoring Systems (DMS), Lane Keeping Assist (LKA), and Automatic Emergency Braking (AEB), enhance driver performance and convenience. For safety, these systems must often communicate seamlessly and reliably with one another to prevent risks to both people and property. As the number of autonomous systems increases, the complexity of the In-vehicular network grows. The stringent requirements on reliability, predictability, bandwidth, and cost for supporting safety-critical and time-critical traffic flows, often pose challenges for communication networks.

Automotive systems are prone to random failures, and if a failure is not communicated in time to system nodes, it could result in fatal consequences. For example, if a failure in a critical system like Automatic Emergency Braking (AEB) or Lane Keeping Assist (LKA) is not communicated efficiently to all other systems, it could lead to accidents. The invention addresses the need for a network that ensures all nodes in an automotive network are aware of a failure within a given timeframe. It is crucial that all nodes can communicate faults reliably and efficiently to guarantee the safety of autonomous systems.

According to the present invention, the term network node refers to all components of the In-vehicular network. Particularly network nodes comprise network switches of the In-vehicular network and end devices of the In-vehicular network, wherein each end device is connected to a corresponding network switch and the network switches are interconnected to build the network structure of the In-vehicular network using Automotive Ethernet. The end devices particularly refer to Electronic Control Units (ECUs), sensors and actuators.

WO2022166407A1 describes a method, device, and system for obtaining vehicle fault prompt information. The method involves gathering user-provided description information, vehicle details, and diagnostic data from a detection device. Target keywords and diagnostic trouble codes (DTCs) specific to the vehicle model are extracted from a database. The diagnostic data is analyzed to identify abnormal items, and relevant prompt information is determined based on these items and pre-set prompts. The system then matches prompt information according to keywords, DTCs, predefined correspondences, providing users with fault location, type, and suggested actions. The fault computing service device consists of a transceiver module to gather information and a processing module to extract keywords, identify abnormal items, and match appropriate prompt information. An electronic device and computer-readable medium are also included, which store and execute the instructions of this fault information retrieval method. It aims to assist users in quickly identifying and addressing vehicle faults by delivering accurate and tailored fault prompts.

US20210335063A1 describes a system that receives multiple fault codes from a vehicle's control system and prioritizes them by identifying root causes of faults and their associated interaction codes. This approach enables an organized hierarchy and efficiency for complex faults and streamlines maintenance vehicles. This prioritization is essential for improving real-time vehicle diagnostics and repair workflows.

US20060083172A1 describes a method for transmitting DTCs across a vehicle's switch fabric network. It includes nodes that facilitate communication between various diagnostic devices and network elements, allowing DTCs to be efficiently routed. It dynamically adapts routes within the network in case of disruptions and enables performance monitoring across the network.

US20220051487A1 describes systems where diagnostic data, including DTCs, is transmitted between vehicle modules and external servers over a network. These systems can prioritize and process DTCs for efficient troubleshooting and may integrate advanced communication protocol and smart contract management to ensure data handling and improved response times.

US20160335816A1 outlines a diagnostic tool interface through web consoles and servers to streamline fault detection and reporting processes.

It is an object of the present invention to provide a quick and reliable distribution of critical events across different Automotive Systems using Automotive Ethernet.

This object is solved according to the invention by a method according to claim 1 and an automotive ethernet device configured to implement the inventive method. Preferred embodiments of the invention are defined in the dependent claims.

The present invention relates to a method for fault communication and handling in In-vehicular networks using automotive ethernet, particularly for safety-critical In-vehicular networks, wherein the In-vehicular network comprises multiple network nodes like network switches and end devices, which are interconnected in a network structure, the method comprising the steps of:
detecting a critical event at one of the network nodes, particularly end device or network switch, of the In-vehicular network, wherein the critical event is detected by the network node affected by the critical event or a network node connected to the network node affected by the critical event;
generating a critical-event message at the physical layer and/or data link layer of the network node detecting the critical event;
broadcasting the critical-event message to the multiple network nodes of the In-vehicular network;
receiving and processing the critical event message at the physical layer and/or data link layer of the automotive ethernet at the other network nodes of the In-vehicular network.

According to the present invention, a distinction between performance traffic and alert traffic is made. Performance traffic refers to normal ethernet frames, such as sensor data, actuator data, video/audio data, or similar data. Alert traffic relates to ethernet frames generated by the method for fault communication and handling in In-vehicular networks using automotive ethernet according to the present invention. The alert traffic particularly relates to critical-event messages generated by the method according to the present invention.

During normal operation of the In-vehicular network using automotive ethernet, a safety-critical event can occur at any time and any network node of the In-vehicular network, i.e. any end device or network switch. This critical event is for example detected by the network node affected by the critical event. Alternatively, the critical event is detected by a network node connected to the network node affected by the critical event. A corresponding critical-event message is generated at the physical layer and/or data link layer of the network node detecting the critical event.

The generated critical-event message is broadcast to the multiple network nodes of the In-vehicular network. For example, the generated critical-event message is forwarded from the generating network node to all other network nodes of the In-vehicular network. This is achieved by each network switch in the in-vehicular network forwarding the critical-event message to all its associated network nodes.

The network nodes receiving the broadcast critical-event message process the critical-event message at the physical layer and/or data link layer of the automotive ethernet.

Thus, the method according to the invention provides a rapid notification of faults and/or critical events across all network nodes of the In-vehicular network, which is crucial to prevent cascading failures and/or to trigger timely corrective actions. Using the inventive method, all network nodes can quickly be aware of a failure and can act accordingly to ensure safety, for example by using mechanisms like fail-passive stop, graceful degradation of functionality, redundancy measures, or other similar mechanisms.

Since the critical-event messages are generated and processed at the physical layer and/or data link layer of the automotive ethernet stack, the message-processing overhead times are minimal. Processing delays caused by higher OSI layers, which may require more complex frame processing schemes, are bypassed. Detecting faults at higher OSI layers consumes significant time, often lasting several tens of milliseconds. Handling faults at the physical layer and/or data link layer prevents such additional delays introduced by processing layers, which can be crucial in safety-critical systems.

Particularly, the safety-critical event messages are generated and processed by the hardware of the In-vehicular network.

This invention is not only restricted to notifying failure of safety-critical components but can also be used for non-safety-critical components such as Displays, Radios, and other infotainment units.

In a variant of the invention, the detected critical event relates to link failures, degradation of link quality, end-device failures, and similar safety or security-related events.

According to a preferred variant of the invention, the critical-event message uniquely identifies the network node and the associated critical event, which has been detected at the respective network node of the In-vehicular network.

Pursuant to a variant of the invention, the critical-event message is generated in hardware through detection of the critical event from the corresponding network node, particularly at the physical layer. The critical event is detected by the network node and upon detection the network node generates in hardware the critical-event message, which is broadcast within the In-vehicular network. Preferably, the critical-event message is generated at the physical layer. All these features significantly reduce the time to communicate faults across the network.

In a further variant of the invention, the physical layer and/or data link layer of each network node comprises an alert handler for generating the critical-event message upon detection of a critical event. The alert handler is also used for decoding and processing critical-event messages upon reception and initiating actions in response to the critical-event message. The responses initiated by the alert handler can be for example: Link Teardown, Redundancy measures, Multicast or Broadcast critical-event message, and so on. The routines and/or responses can be defined in a database at the physical layer and/or data link layer of each network node.

According to an advantageous variant of the invention, the automotive ethernet comprises multiple virtual local area networks, wherein each virtual local area network is identified by a respective tag, and wherein each critical-event message comprises the tag of the virtual local network in which the network node of the In-vehicular network is located that detected critical event. The VLAN tag can regulate and localize the critical-event message within the respective broadcast domain across the network.

Pursuant to an expedient variant of the invention, each network node uses a message filter for inspecting, regulating, and/or discarding critical event messages. The message filter can control how the critical-event messages are processed by the receiving network nodes. Using a filter is quick and easy, which is essential for processing safety-critical-event messages, and makes the network more secure.

In a preferred variant of the invention, each network node uses a database or look-up table for processing critical event messages, wherein the database or look-up table comprises one or more of the following information: network node identifications, virtual local area network tags, critical-event identifications, fault handling routine information for network nodes, or other information required for generating and/or processing critical-event messages. The database or look-up table at each network node reduces the overall time until a critical event is detected, broadcast, and processed at all network nodes of the In-vehicular network.

According to a variant of the invention, the content of the database or look-up table can be configured and is preferably harmonized for all network nodes of the In-vehicular network.

The complexity of today's In-vehicular networks (IVN) is very high. The guaranteed transfer of safety-critical and time-critical data in Time-Sensitive Networks (TSN) is very challenging. Furthermore, ensuring the reliable transfer of critical event information demands significant design and testing efforts for the IVN. A buffer overrun leading to frame drops in a TSN environment is a critical issue, especially given TSN's goal to ensure deterministic, low-latency, and lossless communication over Ethernet. Improper Scheduling, excessive traffic, and insufficient buffer size are all causes of buffer overrunning in TSNs. Even when a critical-event message is generated quickly, according to the invention, if the existing OSI stack (which is used to transfer audio/video/sensor/actuator data) is to be used for broadcasting it, timely delivery cannot be guaranteed (because it cannot be differentiated among other types, and it will be vulnerable to buffer overrun). The present invention addresses this issue for example by using a critical network switch dedicated to routing only critical event messages. Since, the traffic through the critical network switch is significantly lower, buffer overruns within it are highly unlikely. Thus, the proposed invention eases IVN design complexity.

Pursuant to an advantageous variant of the invention, the In-vehicular network comprises a critical network switch for transmitting and receiving only critical-event messages inside the In-vehicular network. Such a critical network switch that only receives and transmits critical event messages increases the performance of the handling of critical events, particularly safety-critical events. The critical network switch is not busy with handling other performance traffic but can directly process the alert traffic. There is no risk of buffering or even buffer overruns and the processing delay of the critical network switch is minimal because it only handles critical-event message.

In a variant of the invention, the critical network switch is connected to each of the multiple network switches, particularly via dedicated links for the critical-event messages. Thus, any received critical-event message can be directly forwarded to any other network switch in the In-vehicular network. Once the critical-event message has been processed by such a critical network switch, each network node of the In-vehicular network receives the broadcast critical-event message. The dedicated links for critical-event messages reduce network traffic-related routing delays. The critical-event messages are transmitted via the dedicated links. Optionally, as form of information redundancy the critically event-messages can be additionally transmitted via the existing OSI stack used for the performance traffic, in case the dedicated links are faulty.

According to a preferred variant of the invention, each of the multiple network switches of the In-vehicular network comprises an internal router, also referred to as alert router, for handling critical-event messages received from or transmitted to the critical network switch and the generated critical-event messages in response to a detected critical event of a network node. Such an internal router for handling critical-event messages guarantees an immediate processing of the critical-event messages received from or transmitted to the critical network.

Pursuant to another variant of the invention, each of the multiple network switches of the In-vehicular network comprises an internal router for receiving critical-event messages from or transmitting critical-event messages to others of the multiple network switches.. In this variant, the critical network switch is not needed. The generated/received critical-event message is transferred through the existing OSI stack, along with other performance traffic, but with higher priority.

In an advantageous variant of the invention, the internal router handles critical-event messages with the highest priority, particularly with a higher priority than normal ethernet traffic frames, and preferably without any buffering, queueing, scheduling, delaying, or similar time-shifted processing.

According to a variant of the invention, the critical-event messages are processed at the physical layer and/or data link layer of the automotive ethernet at the multiple network nodes of the In-vehicular network with the highest priority and particularly without any buffering, queueing, scheduling, delaying or similar time-shifted processing.

The object is further solved by an automotive ethernet device for fault communication and handling in In-vehicular networks, wherein the system is configured to implement the method according to the invention.

In a variant of the invention, each of the multiple network nodes comprises an alert handler that is configured to receive or detect the critical event of the corresponding network node or a connected network node, wherein the alert handler is located at the physical layer and/or data link layer.

In the following, the invention will be further explained with respect to the embodiments shown in the figures. It shows:

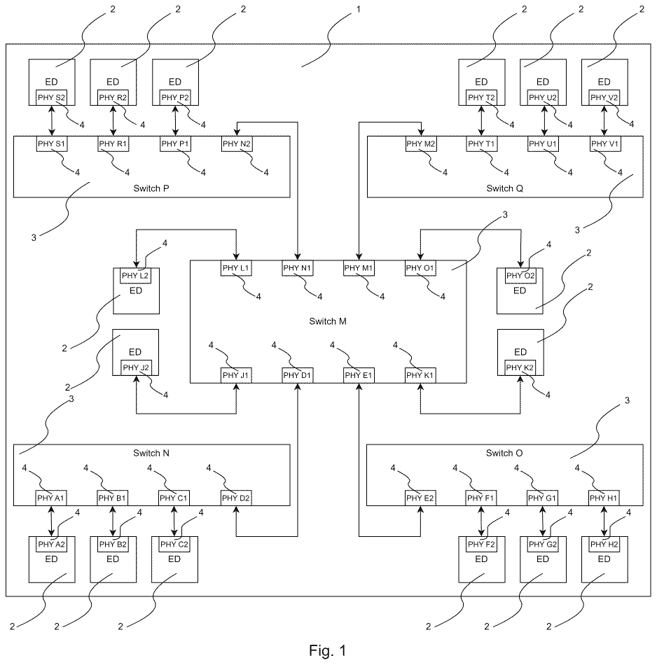

FIG. 1 a schematic view of a general in-vehicular network;

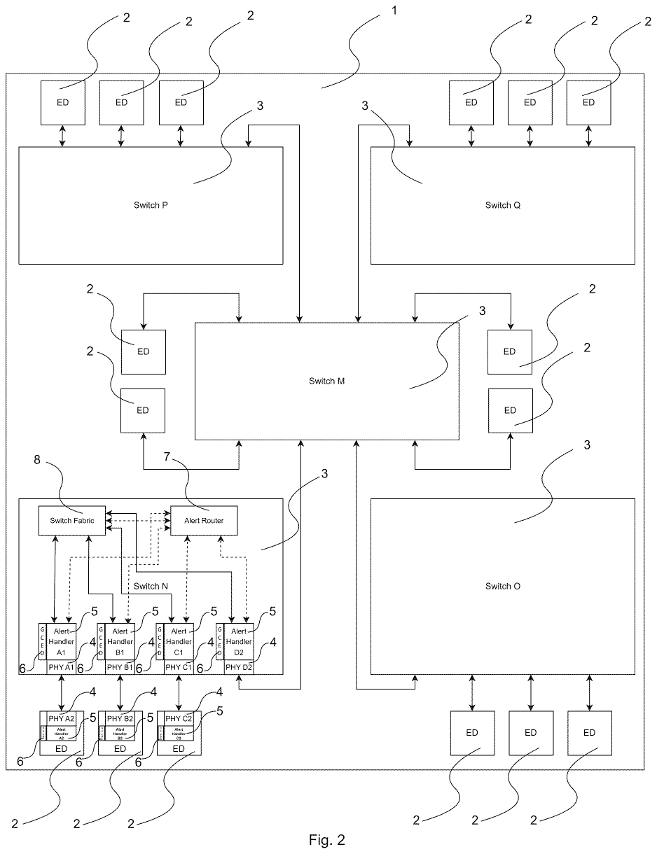

FIG. 2 a schematic view of a first embodiment of a general In-vehicular network configured to implement the method for fault communication and handling in In-vehicular networks using automotive ethernet according to the invention;

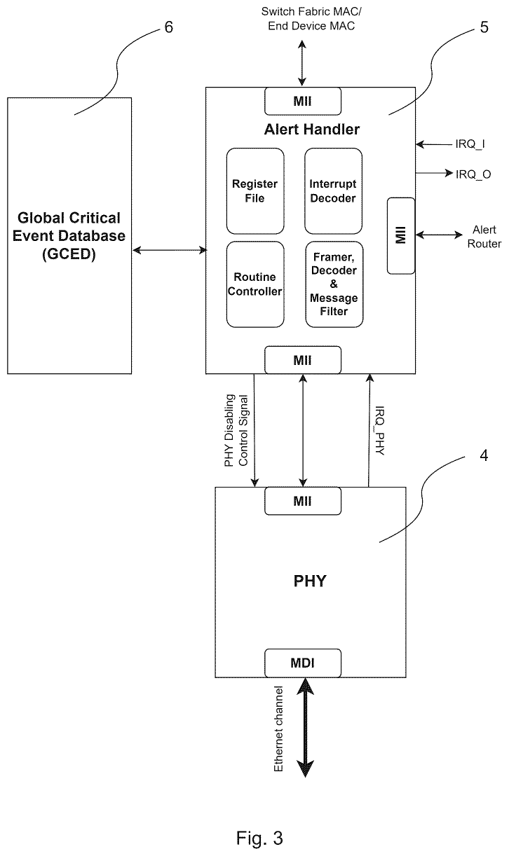

FIG. 3 a schematic view of an alert handler at the physical layer and/or data link layer for implementing the method for fault communication and handling in In-vehicular networks using automotive ethernet according to the invention; and

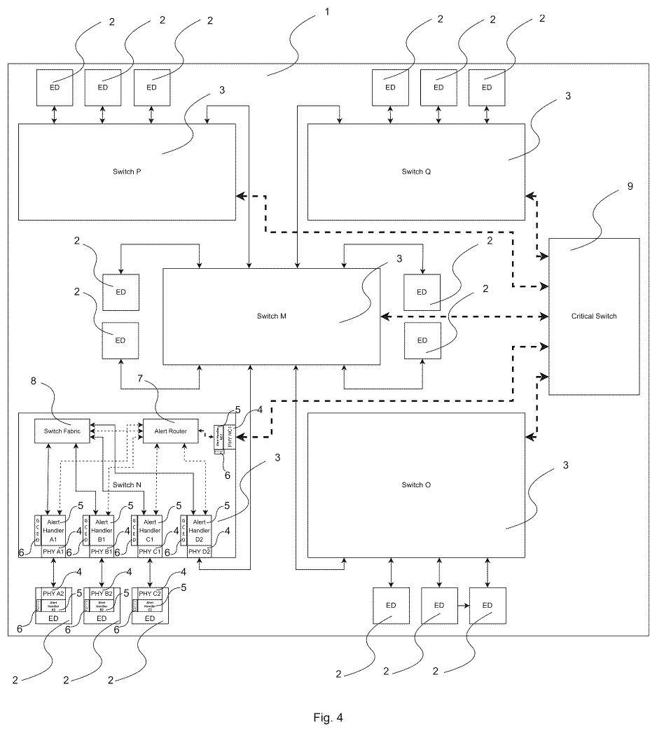

FIG. 4 a schematic view of a second embodiment of a general In-vehicular network configured to implement the method for fault communication and handling in In-vehicular networks using automotive ethernet according to the invention.

FIG. 1 shows a schematic view of a general In-vehicular network 1 using automotive ethernet. The In-vehicular network 1 comprises multiple network nodes 2, 3. A network node 2,3 according to the present invention is a network component that can create, store and/or process frames and particularly refers to End Devices (ED), such as sensors, actuators, Electronic Control Units (ECU), infotainment units, or similar components of a modern automotive system or network switches 3. The network nodes 2, 3, particularly the end devices 2 are interconnected by multiple network switches 3. The multiple network nodes 2, 3 each comprise one or more physical layer devices (PHY) 4, one physical layer device (PHY) 4 for each connection to an end device 2 and/or network switch 3.

The connection between the physical layer device 4 of the networks nodes 2 and the physical layer device 4 of the corresponding network switch 3 and/or between the physical layer devices 4 of interconnected network switches 3 is referred to as (network) channel, communication connection or link. The (network) channels, communication connections or links are shown in FIG. 1 as lines having double arrows.

For instance, consider the following scenario which explains the flow of performance traffic in the In-vehicular network 1 shown in FIG. 1. When traffic from PHY A2 of end device 2 (the network node 2 at the bottom left) is directed to PHY O2 of end device 2 (network node 2 in the middle on the right side), ethernet frames travel from PHY A1 through the ethernet channel to switch N3, where layer 2 protocols are applied. From there, they are routed to switch M3, processed by layer 2/layer 3 protocols, and finally sent to PHY O2 via PHY O1. Routing through these switches 3 is non-deterministic; the state of INGRESS and EGRESS buffers in switches N and M3 can cause the ethernet frames from PHY A1 to experience variable delays, influenced by factors such as priorities, credits, and routing protocols. If the buffers are full, frames may be dropped.

Ingress and Egress Buffers: Each switch 3, like N and M, has ingress (input) and egress (output) buffers that temporarily store frames as they wait to be processed or sent out. If these buffers are crowded or full, frames might experience delays or, in some cases, even be dropped (not transmitted).

Traffic Prioritization and Protocols: Within the switches 3, frames may receive different priorities based on the type of traffic, credits, or routing protocols. Higher-priority frames may be processed more quickly, while lower-priority frames might experience more waiting time, causing further variability in delay.

Typically, a lot of effort is put into designing the In-vehicular network 1 such that critical performance traffic, such as actuator data reaches the intended destination without packet loss. However, it is to be noted that even with the highest priority, variable delays and packet loss exist.

If a failure occurs (for example, in PHY A2 or its connected end device 2), it is essential that this information is quickly communicated to all relevant network nodes 2, 3 without exception. Delays or failures in notifying other network nodes 2, 3 could lead to serious safety risks. However, in current In-vehicular networks 1, the process of communicating failures is often slow, typically taking several tens of milliseconds. In some cases, it is not done properly and has resulted in safety hazards.

FIG. 2 shows a schematic view of a first embodiment of a general In-vehicular network 1 configured to implement the method for fault communication and handling in In-vehicular networks 1 using automotive ethernet according to the invention.

The method for fault communication and handling in In-vehicular networks 1 using automotive ethernet according to the present invention presents an effective approach that communicates critical events (such as a nodal failure) to all relevant network nodes 2, 3 in a timely manner. The invention generally relates to broadcasting of critical events in the complete system to alert relevant events for all functions that need to know and must handle according to those alerts. Alerts can be generated from any kind of system incident. No matter if it is safety-related, security related, or functional safety-related.

The method for fault communication and handling in In-vehicular networks 1 using automotive ethernet according to the present invention comprises the steps of:
Detecting a critical event at one of the network nodes 2, 3, particularly end device 2 or network switch 3, of the In-vehicular network 1, wherein the critical event is detected by the network node 2, 3 affected by the critical event or by a network node 2, 3 connected to the network node 2, 3 affected by the critical event;
generating a critical-event message at the physical layer and/or data link layer 4 of the network node 2, 3 detecting the critical event;
broadcasting the critical-event message to the multiple network nodes 2, 3 of the In-vehicular network 1;
receiving and processing critical event message at the physical layer and/or data link layer 4 of the automotive ethernet at the other network nodes 2, 3 of the In-vehicular network 1.

The detected critical event relates to link failures, end device 2 failures, and similar safety or security-related events.

The critical-event message uniquely identifies the network node 2, 3 and the associated critical event, which has been detected at the respective network node 2, 3 of the In-vehicular network 1.

Preferably, the critical-event message is generated in hardware (e.g. by an alert handler 5) through detection of the critical event from the corresponding network node 2, 3, particularly at the physical layer.

According to the first embodiment shown in FIG. 2 the critical-event messages are handled by internal alert routers 7 of network switches 3, particularly for receiving or transmitting critical-event messages between the multiple network switches 3. In FIG. 2 the internal alert router 7 is only shown for the network switch 3 at the bottom left for clarity purposes, but every network switch 3 comprises such an internal alert router 7, although they are not all shown in FIG. 2.

The internal alert routers 7 of the network switches 3 are used for broadcasting the generated critical-event messages within the whole In-vehicular network 1.

Each network switch 3 further comprises a switch fabric 8, which handles the performance traffic in the In-vehicular network 1.

According to the first embodiment shown in FIG. 2, the performance traffic and the alert traffic (critical-event messages) are transmitted via the same channels between the multiple network switches 3 and between the network switches 3 and the corresponding end nodes 2. However, the critical-event messages are processed at the physical layer and/or data link layer 4 of the automotive ethernet at the multiple network nodes 2, 3 of the In-vehicular network 1 with the highest priority and particularly without any buffering, queueing, scheduling, delaying or similar time-shifted processing.

Preferably, the physical layer and/or data link layer 4 of each network node 2, 3 comprises an alert handler 5 for decoding and processing critical event messages upon reception and initiating actions in response to the critical-event message.

FIG. 3 shows a schematic view of such an alert handler 5 at the physical layer and/or data link layer 4 for implementing the method for fault communication and handling in In-vehicular networks 1 using automotive ethernet according to the invention.

Alert handler 5 is for example a soft IP integrated on top of every PHY instance 4 in the In-vehicular network 1, i.e. each network node 2, 3. It handles safety interrupts from all sub-components: associated PHY 4, associated MAC device, associated network nodes 2, 3 and neighboring alert handlers 5 and is used to create critical-event messages (Alert traffic).

In an advantageous variant of the invention, each network node 2, 3 or corresponding alert handler 5 uses a database 6 or look-up table for processing critical event messages, wherein the database 6 or look-up table comprises one or more of the following information: network node 2, 3 identifications, virtual local area network tags, critical event identifications, fault handling routine information for network nodes 2, 3 or other information required for generating and/or processing critical-event messages. The content of the database 6 or look-up table can be advantageously configured and is preferably harmonized for all network nodes 2, 3 and/or alert handlers 5 of the In-vehicular network 1.

Depending on the interrupt raised or critical event detected, the corresponding component ID is fetched from the database 6. A corresponding VLAN tag, if applicable, and other necessary information required for forming the critical-event message are obtained from user configurations. Furthermore, fault handling routines (how to handle a detected failure) are specified for each component in the database 6. Examples of fault handling routines can be: Link Teardown, Switch to Redundancy, Multicast Alert message, Broadcast alert message and so on.

The In-vehicular network 1, i.e. the automotive ethernet, may comprise multiple virtual local area networks (VLANs), wherein each virtual local area network is identified by a respective tag, and wherein each critical event message comprises the tag of the virtual local network in which the network node 2 of the In-vehicular network 1 is located that detected the critical event.

Furthermore, each network node 2, 3 may use a message filter for inspecting, regulating and/or discarding critical-event messages.

FIG. 4 shows a schematic view of a second embodiment of a general In-vehicular network 1 configured to implement the method for fault communication and handling in In-vehicular networks 1 using automotive ethernet according to the invention.

The second embodiment of FIG. 4 differs from the first embodiment of FIG. 2 in that the critical-event messages are transmitted via dedicated channels (links) (dotted lines in FIG. 4) and a dedicated critical network switch 9. The critical network switch 9 is used for transmitting and receiving only critical-event messages inside the In-vehicular network 1.

Therefore, each network switch 3 of the In-vehicular network 1 comprises a further physical layer device 4 which is connected via a dedicated channel (link) to a corresponding physical layer device 4 (not shown in FIG. 4) of the critical network switch 9.

The internal alert routers 7 of each of the multiple network switches 3 of the In-vehicular network 1 are used for handling critical-event messages received from or transmitted to the critical network switch 9 and the generated critical-event messages in response to a detected critical event of a network node 2, 3.

In case the critical network 9 itself is affected by a critical event, the critical-event messages can be transmitted by the network switches 3 via the performance traffic links, according to the functionality of the first embodiment shown in FIG. 2.

### LIST OF REFERENCES

1 In-vehicular network
2 End Device (network node)
3 network switch (network node)
4 physical layer device
5 alert handler
6 database
7 alert router
8 switch fabric
9 critical network switch

1. A method for fault communication and handling in In-vehicular networks using automotive ethernet, particularly for safety-critical In-vehicular networks, wherein the In-vehicular network comprises multiple network nodes like network switches and end devices, which are interconnected in a network structure, the method comprising the steps of:
detecting a critical event at one of the network nodes, particularly end device or network switch, of the In-vehicular network, wherein the critical event is detected by the network node affected by the critical event or by a network node connected to the network node affected by the critical event;
generating a critical-event message at the physical layer and/or data link layer of the network node detecting the critical event;
broadcasting the critical-event message to the multiple network nodes of the In-vehicular network;
receiving and processing the critical event message at the physical layer and/or data link layer of the automotive ethernet at the other network nodes of the In-vehicular network.

2. The method for fault communication and handling in In-vehicular networks using automotive ethernet according to claim 1,
wherein the detected critical event relates to link failures, end-device failures, and similar safety or security-related events.

3. The method for fault communication and handling in In-vehicular networks using automotive ethernet according to claim 1,
wherein the critical-event message uniquely identifies the network node and the associated critical event, which has been detected at the respective network node of the In-vehicular network.

4. The method for fault communication and handling in In-vehicular networks using automotive ethernet according to any of claim 1.
wherein the critical-event message is generated in hardware through detection of the critical event from the corresponding network node, particularly at the physical layer.

5. The method for fault communication and handling in In-vehicular networks using automotive ethernet according to any of claim 1,
wherein the physical layer and/or data link layer of each network node comprises an alert handler for generating, decoding and processing critical event messages.

6. The method for fault communication and handling in In-vehicular networks using automotive ethernet according to any of claim 1,
wherein the automotive ethernet comprises multiple virtual local area networks, wherein each virtual local area network is identified by a respective tag, and wherein each critical-event message comprises the tag of the virtual local network in which the network node of the In-vehicular network is located that detected the critical event.

7. The method for fault communication and handling in In-vehicular networks using automotive ethernet according to claim 1,
wherein each network node uses a message filter for inspecting, regulating and/or discarding critical event messages.

8. The method for fault communication and handling in In-vehicular networks using automotive ethernet according to claim 1,
wherein each network node uses a database or look-up table for processing critical event messages, wherein the database or look-up table comprises one or more of the following information: network node identifications, virtual local area network tags, critical event identifications, fault handling routine information for network nodes, or other information required for generating and/or processing critical-event messages.

9. The method for fault communication and handling in In-vehicular networks using automotive ethernet according to claim 1,
wherein the content of the database or look-up table can be configured and is preferably harmonized for all network nodes of the In-vehicular network.

10. The method for fault communication and handling in In-vehicular networks using automotive ethernet according to claim 1,
wherein the In-vehicular network comprises a critical network switch for transmitting and receiving only critical-event messages inside the In-vehicular network.

11. The method for fault communication and handling in In-vehicular networks using automotive ethernet according to claim 10,
wherein the critical network switch is connected to all other network switches of the In-vehicular network, particularly via dedicated links for the critical-event messages.

12. The method for fault communication and handling in In-vehicular networks using automotive ethernet according to claim 10,
wherein each of the multiple network switches of the In-vehicular network comprises an internal router for handling critical-event messages received from or transmitted to the critical network switch and the generated critical-event messages in response to a detected critical event.

13. The method for fault communication and handling in In-vehicular networks using automotive ethernet according to claim 1,
wherein each of the multiple network switches of the In-vehicular network comprises an internal router for receiving critical event messages from or transmitting critical-event messages to others of the multiple network switches.

14. The method for fault communication and handling in In-vehicular networks using automotive ethernet according to claim 12,
wherein the internal router handles critical-event messages with the highest priority, particularly with a higher priority than normal ethernet traffic frames, and preferably without any buffering, queueing, scheduling, delaying, or similar time-shifted processing.

15. The method for fault communication and handling in In-vehicular networks using automotive ethernet according to claim 1,
wherein the critical-event messages are processed at the physical layer and/or data link layer of the automotive ethernet at the multiple network nodes of the In-vehicular network with the highest priority and particularly without any buffering, queueing, scheduling, delaying or similar time-shifted processing.

16. An automotive ethernet device for fault communication and handling in In-vehicular networks, wherein the system is configured to implement the method according to claim 1.

17. The automotive ethernet device for fault communication and handling in In-vehicular networks according to claim 16,
wherein each of the multiple network nodes comprises an alert handler that is configured to receive or detect the critical event of the corresponding network node or a connected network node, wherein the alert handler is located at the physical layer and/or data link layer.

18. The method for fault communication and handling in In-vehicular networks using automotive ethernet according to claim 2,
wherein the critical-event message uniquely identifies the network node and the associated critical event, which has been detected at the respective network node of the In-vehicular network.

19. The method for fault communication and handling in In-vehicular networks using automotive ethernet according to claim 18,
wherein the physical layer and/or data link layer of each network node comprises an alert handler for generating, decoding and processing critical event messages.

20. The method for fault communication and handling in In-vehicular networks using automotive ethernet according to claim 19,
wherein the automotive ethernet comprises multiple virtual local area networks, wherein each virtual local area network is identified by a respective tag, and wherein each critical-event message comprises the tag of the virtual local network in which the network node of the In-vehicular network is located that detected the critical event.
